(19) United States
(12) Patent Application Publication
(10) Pub. No.: US 2020/0356164 A1
(43) Pub. Date: Nov. 12, 2020

(54) DISPLAY SYSTEM AND DISPLAY DEVICE

(71) Applicant: Japan Display Inc., Tokyo (JP)

(72) Inventors: Toshihiro YANAGI, Tokyo (JP); Kei TAMURA, Tokyo (JP)

(21) Appl. No.: 16/941,764

(22) Filed: Jul. 29, 2020

Related U.S. Application Data
(63) Continuation of application No. PCT/JP2018/030820, filed on Aug. 21, 2018.

(30) Foreign Application Priority Data
Jan. 31, 2018 (JP) 2018-015917

(51) Int. Cl. G06F 3/01; G09G 5/37; G09G 5/14

(52) U.S. Cl. CPC G06F 3/012; G09G 5/37; G09G 2330/02; G09G 5/14; G06F 3/013

(57) ABSTRACT

According to an aspect, a display system includes: a display device attached to VR goggles; and an information processing device configured to output an image to the display device. The display device includes a sensor configured to supply a detection signal indicating a motion of the display device, and a display part. The information processing device includes an information processor configured to receive information detected by the sensor of the display device and generate an image signal based on the received information. The display part of the display device displays an image based on the image signal generated by the information processor.

### CROSS-REFERENCE TO RELATED APPLICATION

This application claims the benefit of priority from Japanese Patent Application No. 2018-015917 filed on Jan. 31, 2018 and International Patent Application No. PCT/2018/030820 filed on Aug. 21, 2018, the entire contents of which are incorporated herein by reference.

### BACKGROUND

### 1. Technical Field

The present disclosure relates to a display system and a display device.

### 2. Description of the Related Art

As described in Japanese Translation of PCT International Application Publication No. 2017-511041, virtual reality (VR) goggles for viewing VR videos using a smartphone are known.

VR goggles using an existing smartphone house an information terminal, such as a smartphone, incorporating a battery and an information processing device that outputs images. When worn on the head of a user with a band or the like or held by the hand of the user, the VR goggles allow the user to view VR videos. Such a smartphone is heavy in weight and is not suitable for long-time use.

For the foregoing reasons, there is a need for a lightweight display device compared with a heavy information terminal and a display system including the display device.

### SUMMARY

According to an aspect, a display system includes a display device attached to VR goggles; and an information processing device configured to output an image to the display device. The display device includes a sensor configured to supply a detection signal indicating a motion of the display device, and at least one display part with an image display panel. The information processing device includes an information processor configured to receive information detected by the sensor and generate an image signal based on the information, and the display part displays an image based on the image signal generated by the information processor.

### BRIEF DESCRIPTION OF THE DRAWINGS

FIG. 1 is a diagram of a main configuration of a display system according to a first embodiment;

FIG. 2 is a diagram of a main configuration of a display unit; FIG. 3 is a sectional view along line A-A of FIG. 2; FIG. 4 is a diagram of an example of a coupling form of a substrate, an image display panel driver, and an image display panel;

FIG. 5 is a diagram of an example of signal flows in the display unit;

FIG. 6 is a diagram of an exemplary main configuration of a display part;

FIG. 7 is a conceptual diagram of the image display panel;

FIG. 8A is a schematic diagram of an example of objects visually recognizable in a VR space by a user wearing VR goggles;

FIG. 8B is a diagram of an example of a three-dimensional image visually recognized by the user corresponding to FIG. 8A;

FIG. 9A is a schematic diagram of an example of the user having a line of sight different from that in FIG. 8A and the objects in the VR space;

FIG. 9B is a diagram of an example of a three-dimensional image visually recognized by the user corresponding to FIG. 9A;

FIG. 10A is a schematic diagram of an example of the user having a line of sight different from that in FIGS. 8A and 9A and the objects in the VR space;

FIG. 10B is a diagram of an example of a three-dimensional image visually recognized by the user corresponding to FIG. 10A;

FIG. 11 is a block diagram of an exemplary main configuration of an information processing device according to a second embodiment;

FIG. 12 is a diagram of an example of the relation between a first distance and two display parts of the VR goggles;

FIG. 13 is a diagram of an example of the relation between the image display panel of the display unit supported by the VR goggles and a second distance;

FIG. 14 is a diagram of an example of the relation between a plurality of types of VR goggles, difference in optical characteristics, and the positions of images for the respective two display parts in a connected image region; and

FIG. 15 is a flowchart of an example of a procedure corresponding to the optical characteristics.

### DETAILED DESCRIPTION

Exemplary embodiments are described below with reference to the accompanying drawings. What is disclosed herein is given by way of example only, and appropriate changes made without departing from the spirit of the present disclosure and easily conceivable by those skilled in the art naturally fall within the scope of the disclosure. To simplify the explanation, the drawings may possibly illustrate the width, the thickness, the shape, and other elements of each unit more schematically than the actual aspect. These elements, however, are given by way of example only and are not intended to limit interpretation of the present disclosure. In the present specification and the figures, components similar to those previously described with reference to previous figures are denoted by the same reference numerals, and detailed explanation thereof may be appropriately omitted.

In this disclosure, when an element is described as being “on” another element, the element can be directly on the other element, or there can be one or more elements between the element and the other element.

### First Embodiment

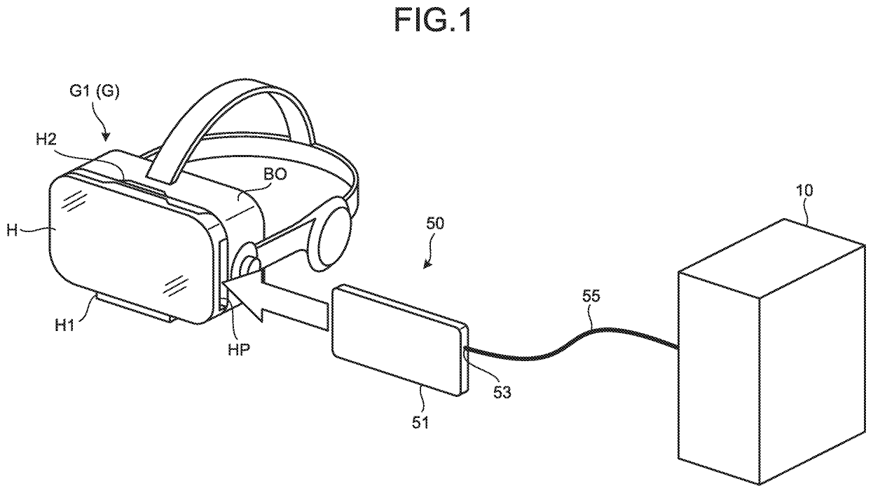

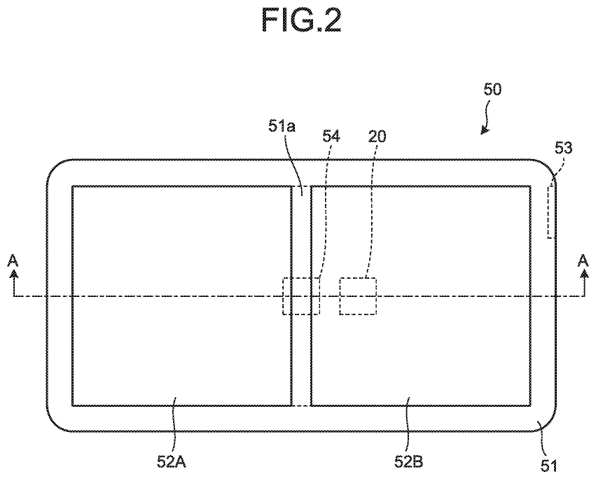

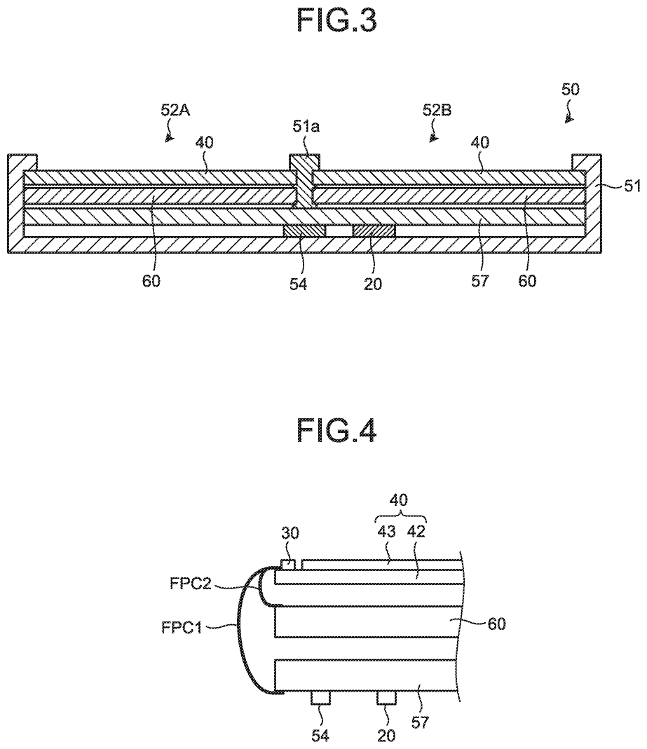

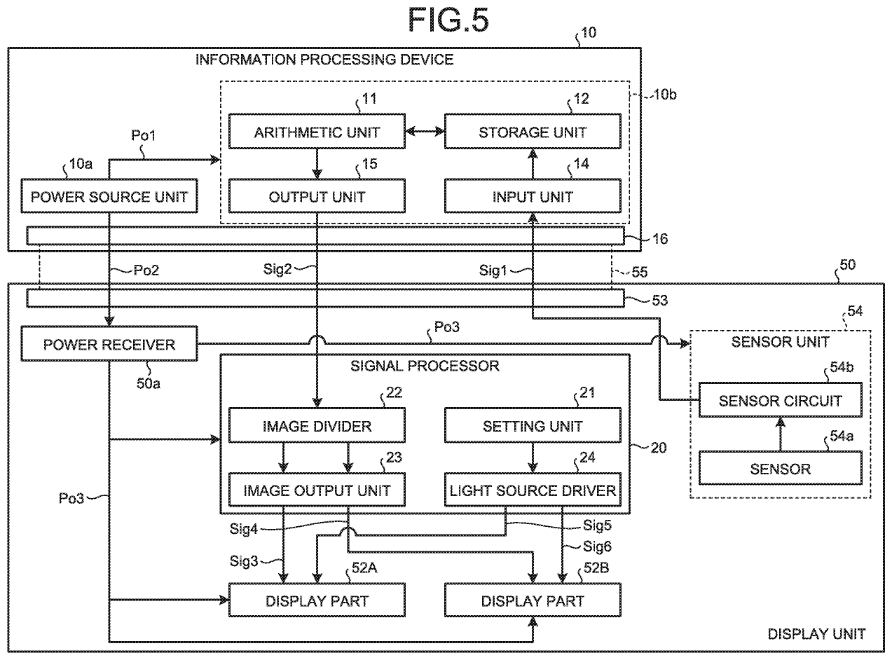

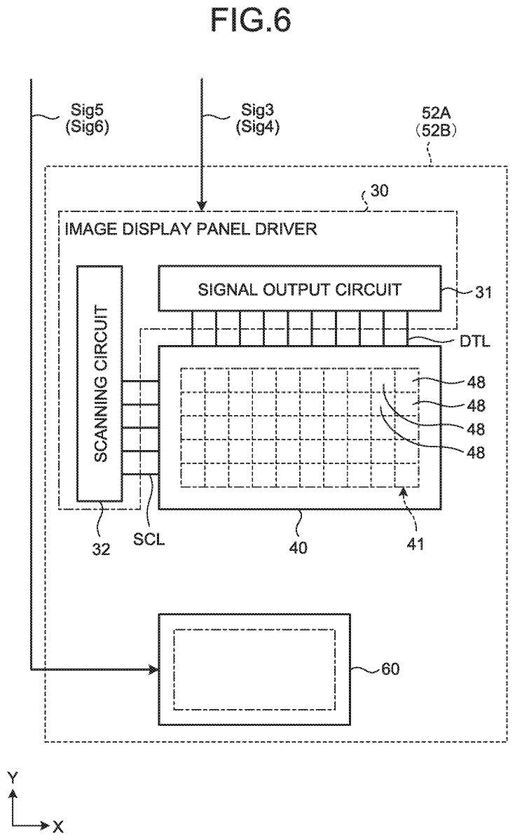

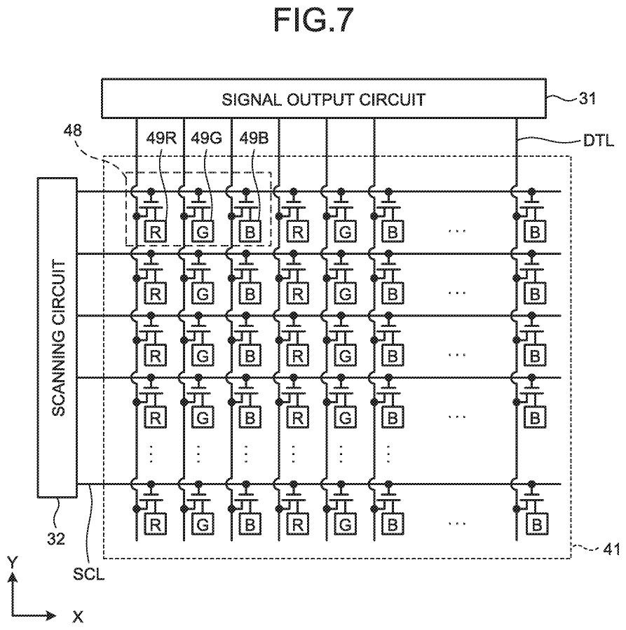

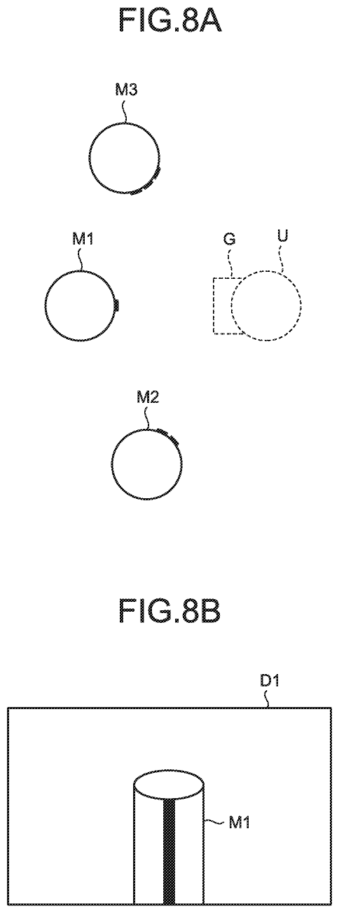

FIG. 1 is a diagram of a main configuration of a display system according to a first embodiment. FIG. 2 is a diagram of a main configuration of a display unit (a display device) 50. FIG. 3 is a sectional view along line A-A of FIG. 2. FIG. 4 is a diagram of an example of a coupling form of a substrate 57, an image display panel driver 30, and an image display panel 40. FIG. 5 is a diagram of an example of signal flows in the display unit 50. FIG. 6 is a diagram of an exemplary main configuration of display parts 52A and 52B. FIG. 7 is a conceptual diagram of the image display panel 40. The display system includes the display unit 50 and an information processing device 10. The display unit 50 is attachable to VR goggles G1. When a user U (refer to FIG. 8A) views an image, the display unit 50 is attached to the VR goggles G1. The VR goggles G1 are a tool that supports the display unit 50 near the head of the user U in a manner aligning the two display parts 52A and 52B of the display unit 50 with the line of sight of the user U.

The VR goggles are not limited to the VR goggles G1 illustrated in FIG. 1 and are any pair of VR goggles of a plurality of types (refer to FIG. 14), which will be described later in detail. A plurality of types of VR goggles may be collectively referred to as VR goggles G. The VR goggles may be any VR goggles that house the display unit 50 and is used supporting the display unit 50 near the head of the user U. The VR goggles are not limited to goggles that display VR videos and may be goggles that display videos of augmented reality (AR), mixed reality (MR), and the like.

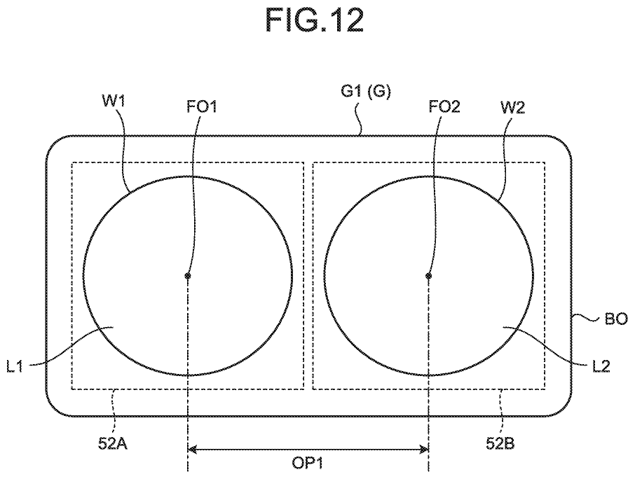

The VR goggles G include a housing BO and a holder H, for example. The housing BO and the holder H are rotatably connected with a hinge H1 serving as a rotation axis, for example. A claw H2 is provided opposite to the hinge H1. The claw H2 is caught on the housing BO to fix the holder H to the housing BO. The display unit 50 is disposed between the housing BO and the holder H. To attach the display unit 50 to the VR goggles G, the gap between the housing BO and the holder H is secured by rotating the holder H with respect to the housing BO with the fixed state of the holder H to the housing BO by the claw H2 released. In this state, the display unit 50 is disposed between the housing BO and the holder H, and the holder H is rotated such that the claw H2 is caught on the housing BO. As a result, the display unit 50 is sandwiched by the holder H and the housing BO. The VR goggles G have an opening HP, for example. In this case, when the display unit 50 is disposed in a housing part, a cable 55 and the display unit 50 may be coupled to each other in a manner passing through the opening HP. The structure of the housing part is not limited thereto. The holder H may be integrated with the housing BO and have an opening into which the display unit 50 can be inserted on the side surface or the upper surface of the holder H. The housing BO has openings W1 and W2 (refer to FIG. 12), which will be described later. The user U visually recognizes images on the display parts 52A and 52B through the openings W1 and W2. In other words, when the display unit 50 is sandwiched by the holder H and the housing BO, the openings W1 and W2 are aligned with the display parts 52A and 52B, respectively. The VR goggles G include, as a fixing part for mounting the VR goggles G on the head of the user U, a ring-shaped band extending along the temporal region and/or a band extending along the parietal region and coupled to the ring-shaped band. The structure of the fixing part is not limited thereto. The fixing part may be the ring-shaped band extending along the temporal region alone or hooks caught on the ears like glasses, or is not necessarily provided. The VR goggles G are held by the fixing part or the hand of the user U to be disposed near the head of the user with the display unit 50 housed therein and are used such that an image displayed by the display unit 50 is displayed in front of the eyes of the user U through the VR goggles G.

The information processing device 10 outputs an image to the display unit 50. The information processing device 10 is coupled to the display unit 50 via the cable 55, for example. The cable 55 transmits signals between the information processing device 10 and the display unit 50. The signals include an image signal Sig2 output from the information processing device 10 to the display unit 50.

As illustrated in FIGS. 2, 3, and 5, for example, the display unit 50 includes a housing 51, the two display parts 52A and 52B, an interface 53, a multi-axis sensor unit 54, a substrate 57, a power receiver 50a, and a signal processor 20.

The housing 51 holds the other components included in the display unit 50. The housing 51, for example, holds the display parts 52A and 52B in a manner disposed side by side with a predetermined gap interposed therebetween. While a partition 51a is provided between the display parts 52A and 52B in the example illustrated in FIG. 2, it is not necessarily provided.

The display parts 52A and 52B are display panels provided in an independently operable manner. The display parts 52A and 52B according to the present embodiment are liquid crystal display panels each including an image display panel driver 30, an image display panel 40, and a light source unit 60.

The image display panel driver 30 controls drive of the image display panel 40 based on signals from the signal processor 20. The image display panel 40 includes a first substrate 42 and a second substrate 43, for example. Liquid crystals constituting a liquid crystal layer, which is not illustrated, are sealed between the first substrate 42 and the second substrate 43. The image display panel driver 30 is provided to the first substrate 42. The light source unit 60 irradiates the image display panel 40 with light from the back surface. The image display panel 40 displays an image by the signals from the image display panel driver 30 and the light from the light source unit 60.

The interface 53 is a coupler to which the cable 55 can be coupled. Specifically, the interface 53 integrates a high definition multimedia interface (HDMI, registered trademark) and a universal serial bus (USB), for example. The cable 55 bifurcates into the HDMI interface and the USB interface in the information processing device 10, which is not illustrated.

The sensor unit 54 is a sensor disposed in the display unit 50 and detects a motion of the display unit 50. In the display system, the sensor unit 54 is a sensor that can detect a motion of the user U by the display unit 50 being housed in the VR goggles and worn by the user U. The sensor unit 54 and the signal processor 20 are circuits provided to the substrate 57. The power receiver 50a that receives power Po2 supplied from the information processing device 10 (refer to FIG. 5) is provided for the sensor unit 54 and the signal processor 20. The interface 53 is coupled to the display parts 52A and 52B, the sensor unit 54, and the signal processor 20 via the substrate 57.

As illustrated in FIG. 4, for example, the substrate 57 and the image display panel driver 30 are electrically coupled to each other via flexible printed circuits (FPC) FPC1. The substrate 57 and the light source unit 60 are electrically coupled to each other via the flexible printed circuits FPC1 and FPC2. The image display panel driver 30 may be a circuit composed of thin film transistor (TFT) elements or the like on the first substrate 42 or an integrated circuit (e.g., an IC chip) disposed on the first substrate 42 or the flexible printed circuits FPC1. The light source unit 60 may be coupled to the integrated circuit via the flexible printed circuits FPC2. In this case, the integrated circuit may include at least part of functions of a light source driver 24, which will be described later.

The display unit 50 does not include any cell (battery) that supplies power for operation. The display unit 50 operates by receiving the power Po2 from the information processing device 10 coupled thereto via the interface 53. Specifically, as illustrated in FIG. 5, for example, the information processing device 10 includes a power source unit 10a, an arithmetic unit 11, a storage unit 12, an input unit 14, an output unit 15, and an interface 16. The power source unit 10a is a power source device included in the information processing device 10 and is coupled to an external power supply source (e.g., an outlet), which is not illustrated. The power source unit 10a supplies power Pol to various components of the information processing device 10, such as the arithmetic unit 11, the storage unit 12, the input unit 14, and the output unit 15 to cause these various components to operate. The power source unit 10a also outputs the power Po2 to cause the display unit 50 to operate.

The interface 16 is a USB interface, for example, including a power transmission terminal. The cable 55 is coupled to the interface 16. The interface 53 is a USB interface, for example, including a power reception terminal. The cable 55 is coupled to the interface 53. With this configuration, the power source unit 10a of the information processing device 10 and the power receiver 50a of the display unit 50 are coupled via a power supply line (e.g., a USB cable) included in the cable 55. The power source unit 10a supplies the power Po2 to the display unit 50 via the interface 16, for example. The power receiver 50a of the display unit 50 receives the power Po2 via the cable 55 and the interface 53.

The power receiver 50a supplies power Po3 based on the power Po2 received via the interface 53 to the signal processor 20 and the display parts 52A and 52B. The signal processor 20 and the display parts 52A and 52B operate using the power Po3 supplied from the power receiver 50a. The power receiver 50a also supplies the power Po3 based on the power Po2 received via the interface 53 to the sensor unit 54. The sensor unit 54 operates using the power Po3 supplied from the power receiver 50a. The power receiver 50a includes a voltage conversion circuit, such as DC/DC converter. The power receiver 50a supplies the power Po3 corresponding to a voltage for causing the various components of the display unit 50, such as the display parts 52A and 52B, the sensor unit 54, and the signal processor 20, to operate based on the power Po2.

The display unit 50 does not include any component (information processor 10b) that performs information processing for generating an image. The display unit 50, for example, does not include any circuit that performs information processing for converting an image based on a motion of the user (display unit 50) detected by the sensor unit 54. The display unit 50 displays an image output from the information processing device 10 coupled thereto via the interface 53. Specifically, the information processing device 10 generates an image corresponding to a detection signal Sig1 indicating a motion of the user U (display unit 50) output from the sensor unit 54 of the display unit 50. The display unit 50 displays the image.

The sensor unit 54 is a circuit that detects a motion of the user U (display unit 50) and includes a sensor 54a and a circuit including a sensor circuit 54b, for example. The sensor 54a is a detection element that acquires signals indicating a motion of the user U (display unit 50), for example. The sensor 54a is a nine-axis sensor including a three-axis angular velocity sensor, a three-axis acceleration sensor, and a three-axis geomagnetic sensor. The sensor circuit 54b is a circuit that outputs the detection signal Sig1 based on the signals acquired by the sensor 54a. The sensor circuit 54b transmits information indicating a direction corresponding to the angular velocity, the acceleration, and the geomagnetism detected by the sensor 54a to the information processing device 10 via the interface 53 as the detection signal Sig1. The sensor 54a is not limited to a nine-axis sensor and may be a six-axis sensor including any two of the angular velocity sensor, the acceleration sensor, and the geomagnetic sensor described above. While the sensor unit 54a outputs the detection signal Sig1 for estimating a motion of the head of the user U when the display unit 50 is housed in the VR goggles G and disposed near the head of the user U, the present embodiment is not limited thereto. The sensor unit 54a may output the detection signal Sig1 indicating a motion of the eyes of the user U. The sensor unit 54a, for example, may include an optical sensor that outputs light having a specific wavelength (e.g., infrared rays) and images reflected light obtained by the output light being reflected by an object. In this case, the sensor unit 54a may include the sensor circuit 54b that outputs the detection signal Sig1 relating to a motion of the eyes based on the captured image. The interfaces 16 and 53 are USB interfaces, for example, each including a terminal that can perform at least one of transmitting and receiving the detection signal. The cable 55 includes wiring that supplies the detection signal.

The information processing device 10 generates an image corresponding to a motion of the user U or the display unit 50 indicated by the detection signal Sig1. The information processing device, for example, generates an image corresponding to the direction of the line of sight of the user U estimated from the direction corresponding to the angular velocity, the acceleration, and the geomagnetism included in the detection signal Sig1. Arithmetic processing relating to generation of the image is performed by the arithmetic unit 11.

The arithmetic unit 11 includes an arithmetic processing device, such as a central processing unit (CPU) or a graphics processing unit (GPU). The arithmetic unit 11 performs processing based on a software program, data, and the like corresponding to the processing contents read from the storage unit 12. In the following description, the term “program” indicates a software program.

The storage unit 12 is a device that stores therein data processed in the information processing device 10 and includes a primary storage device and a secondary storage device. The primary storage device functions as a random access memory (RAM), such as a dynamic random access memory (DRAM). The secondary storage device includes at least one of a hard disk drive (HDD), a solid state drive (SSD), a flash memory, and a memory card.

The input unit 14 receives input of information to the information processor 10b. The input unit 14, for example, receives the detection signal Sig1 input via the interface 16 and transmits it to the arithmetic unit 11.

The arithmetic unit 11 performs arithmetic processing for generating an image corresponding to the direction based on the angular velocity, the acceleration, and the geomagnetism indicated by the detection signal Sig1. The output unit 15 of the information processing device 10 draws the image generated by the arithmetic operation performed by the arithmetic unit 11 and outputs the drawn image to the display unit 50.

The output unit 15 performs output corresponding to the contents of processing performed by the information processor 10b. Specifically, the output unit 15, for example, includes a video card that generates image data and outputs an image signal Sig2.

The interface 16 or the interface 53 according to the present embodiment includes an interface having a terminal that performs at least one of transmitting and receiving the image signal Sig2 and includes an HDMI interface, for example. The output unit 15 outputs the image signal Sig2 via the HDMI interface, for example. The image signal Sig2, for example, function as a signal constituting a frame image including two three-dimensional images for causing the user U to visually recognize a three-dimensional VR image using the two display parts 52A and 52B. The cable 55 includes image signal supply wiring and transmits the image signal Sig2 via the interface 16. The interface 53 of the display unit 50 transmits the received image signal Sig2 to the signal processor 20.

The signal processor 20 divides the image signal Sig2 to generate output signals Sig3 and Sig4. The signal processor 20 outputs the output signal Sig3 to the display part 52A. The signal processor 20 outputs the output signal Sig4 to the display part 52B.

The signal processor 20 includes a setting unit 21, an image divider 22, an image output unit 23, and a light source driver 24, for example. The setting unit 21 holds setting information on a motion of the display unit 50. Specifically, the setting unit 21 holds setting relating to the brightness of the image to be displayed, for example.

The image divider 22 divides the image signal Sig2 to generate the output signals Sig3 and Sig4. The image divider 22 includes a circuit that converts the image signal Sig2 serving as a video signal conforming to HDMI standards into video signals conforming to mobile industry processor interface (MIPI, registered trademark) standards, for example. The image divider 22 divides the image signal Sig2 into the output signals Sig3 and Sig4 such that an image corresponding to an image region having a size equal to the sum of the sizes of image display regions 41 of the two display parts 52A and 52B included in the image signal Sig2 is divided into images corresponding to the image display regions 41 of the respective two display parts 52A and 52B.

If 1440×1700 pixels 48 are disposed in the image display region 41, for example, the number of pixels of a frame image based on the image signal Sig2 corresponding to the video signal for a connected image region is 2880×1700. The number of pixels 48 in the image display region 41 and the number of pixels of the image corresponding to the connected image region are given by way of example only. The number of pixels 48 and the number of pixels of the image are not limited thereto and may be appropriately modified.

The image output unit 23 outputs the output signals Sig3 and Sig4 generated by the image divider 22. Specifically, the image output unit 23 outputs the output signal Sig3 to the image display panel driver 30 of the display part 52A. The image output unit 23 outputs the output signal Sig4 to the image display panel driver 30 of the display part 52B. As described above, the output signal Sig3 for the display part 52A and the output signal Sig4 for the display part 52B are individual signals. The display part 52A and the display part 52B display individual images.

The light source driver 24 controls operations of the light source unit 60. The light source driver 24, for example, outputs a control signal Sig5 to the light source unit 60 of the display part 52A. The control signal Sig5 is a signal for performing control such that the brightness of light from the light source unit 60 included in the display part 52A is equal to the brightness corresponding to the image displayed based on the output signal Sig3 and the setting held in the setting unit 21. The light source driver 24 outputs a control signal Sig6 to the light source unit 60 of the display part 52B. The control signal Sig6 is a signal for performing control such that the brightness of light from the light source unit 60 included in the display part 52B is equal to the brightness corresponding to the image displayed based on the output signal Sig4 and the setting held in the setting unit 21.

As illustrated in FIG. 6, the image display panel 40 includes a plurality of pixels 48 arrayed in a two-dimensional matrix (row-column configuration) in the image display region 41. In the example illustrated in FIG. 6, a plurality of pixels 48 are arrayed in a matrix (row-column configuration) in the X-Y two-dimensional coordinate system. While the X-direction in this example is the row direction, and the Y-direction is the column direction, the directions are not limited thereto. The X-direction may be the vertical direction, and the Y-direction may be the horizontal direction.

As illustrated in FIG. 7, the pixels 48 each include a first sub-pixel 49R, a second sub-pixel 49G, and a third sub-pixel 49B. The first sub-pixel 49R displays a first color (e.g., red). The second sub-pixel 49G displays a second color (e.g., green). The third sub-pixel 49B displays a third color (e.g., blue). The first, the second, and the third colors are not limited to red, green, and blue, respectively. They may be complementary colors, for example, and simply need to be different colors. In the following description, the first sub-pixel 49R, the second sub-pixel 49G, and the third sub-pixel 49B are referred to as sub-pixels 49 when they need not be distinguished from one another. In other words, one of the three colors is allocated to one sub-pixel 49. Four or more colors may be allocated to the respective sub-pixels 49 constituting one pixel 48.

The image display panel 40 is a transmissive color liquid crystal display panel, for example. The image display panel 40 includes a first color filter that allows light in the first color to pass therethrough between the first sub-pixel 49R and the user U. The image display panel 40 also includes a second color filter that allows light in the second color to pass therethrough between the second sub-pixel 49G and the user U. The image display panel 40 also includes a third color filter that allows light in the third color to pass therethrough between the third sub-pixel 49B and the user U.

The image display panel driver 30 includes a signal output circuit 31 and a scanning circuit 32. The image display panel driver 30 causes the signal output circuit 31 to hold an image signal included in an output signal (output signal Sig3 or output signal Sig4) and sequentially output it to the image display panel 40. More specifically, the signal output circuit 31 outputs, to the image display panel 40, an image signal having a predetermined electric potential corresponding to the output signal (output signal Sig3 or output signal Sig4) from the signal processor 20. The signal output circuit 31 is electrically coupled to the image display panel 40 via signal lines DTL. The scanning circuit 32 controls turning on and off of switching elements that control operations (light transmittance) of the sub-pixels 49 in the image display panel 40. The switching element is a thin-film transistor (TFT), for example. The scanning circuit 32 is electrically coupled to the image display panel 40 via scanning lines SCL. The scanning circuit 32 outputs a drive signal to a predetermined number of scanning lines SCL to drive the sub-pixels 49 coupled to the scanning line SCL to which the drive signal is output. The switching elements of the sub-pixels 49 are turned on in accordance with the drive signal and transmit the electric potential corresponding to the image signal to pixel electrodes and potential holders (e.g., condensers) of the sub-pixels 49 via the signal lines DTL. Liquid crystal molecules included in the liquid crystal layer of the image display panel 40 determine the orientation corresponding to the electric potential of the pixel electrodes. As a result, the light transmittance of the sub-pixels 49 is controlled. The scanning circuit 32 sequentially shifts the scanning line SCL to which the drive signal is output, thereby scanning the image display panel 40.

The light source unit 60 is disposed on the back surface of the image display panel 40. The light source unit 60 outputs light to the image display panel 40, thereby illuminating the image display panel 40.

The following describes generation of an image performed by the information processor 10b of the information processing device 10 based on the detection signal Sig1 from the sensor unit 54 with reference to FIGS. 8A to 13.

FIG. 8A is a schematic diagram of an example of objects M1, M2, and M3 visually recognizable in a VR space by the user U wearing the VR goggles G. FIG. 8B is a diagram of an example of a three-dimensional image D1 visually recognized by a user U1 corresponding to FIG. 8A. The information processing device 10 outputs an image corresponding to the direction of the display unit 50 detected by the sensor unit 54. The information processing device 10, for example, receives the detection signal Sig1 serving as an initial set value from the sensor unit 54. The initial set value may be obtained by automatically setting the detection signal Sig1 received at a timing of receiving an input signal for starting to view a VR video by the user U or by setting the detection signal Sig1 received at a timing of receiving an input signal for specifying initial setting by the user U at a desired timing. The information processing device 10 receives the detection signal Sig1 and stores it in the storage unit 12 as the initial set value. Subsequently, the information processing device 10 outputs an image corresponding to a predetermined initial region in the VR space. As illustrated in FIG. 8A, for example, the initial region is a region corresponding to the direction facing the object M1 from the position of the user U, with respect to the position of the user U serving as an initial point of view. The information processing device 10 generates an image for the display part 52A corresponding to the initial region and an image for the display part 52B corresponding to the initial region. The information processing device 10 outputs a connected image obtained by connecting these generated images to the display unit 50 as the image signal Sig2. The information processing device 10, for example, may have the point of view corresponding to the right eye of the user U and the point of view corresponding to the left eye of the user U as the initial point of view. In this case, the information processing device 10 may generate images corresponding to the direction facing the object M1 from the receptive points of view and output a connected image obtained by connecting these images. The display unit 50 displays images on the respective display parts 52A and 52B based on the image signal Sig2. The user U watches the images displayed on the display parts 52A and 52B through lenses or the like included in the VR goggle G, thereby viewing the three-dimensional image D1 illustrated in FIG. 8B.

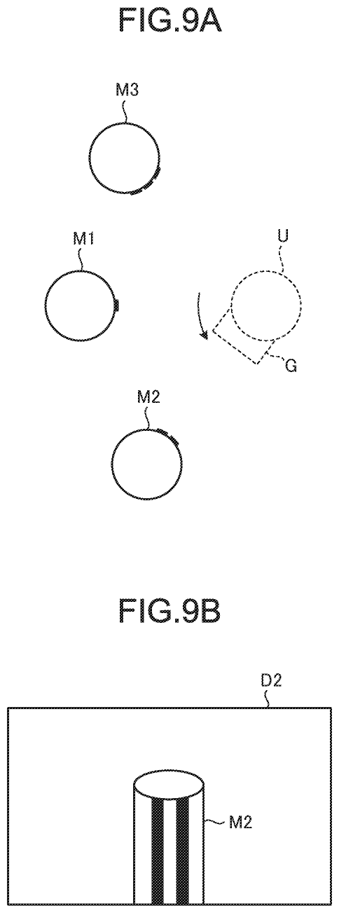

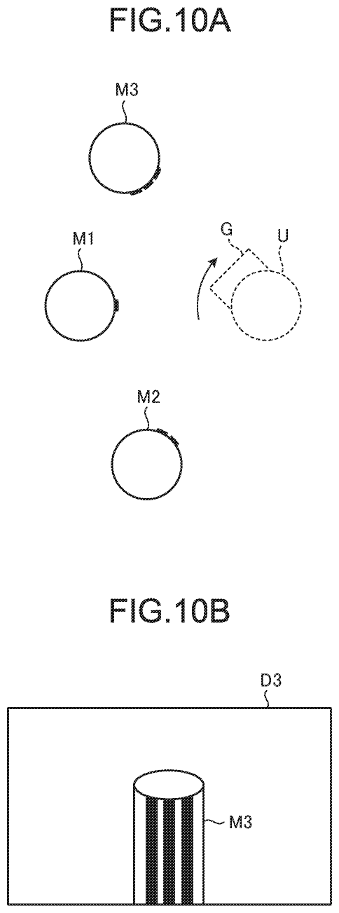

FIG. 9A is a schematic diagram of an example of the user U having a line of sight different from that in FIG. 8A and the objects M1, M2, and M3 in the VR space. FIG. 9B is a diagram of an example of a three-dimensional image D2 visually recognized by the user U1 corresponding to FIG. 9A. FIG. 10A is a schematic diagram of an example of the user U having a line of sight different from that in FIGS. 8A and 9A and the objects M1, M2, and M3 in the VR space. FIG. 10B is a diagram of an example of a three-dimensional image D3 corresponding to FIG. 10A. If the user U wearing the VR goggles G changes the line of sight, the sensor unit 54 detects a change in the direction of the display unit 50. If the sensor unit 54 detects a change in the direction of the display unit 50, the information processing device 10 changes the drawing contents of an image to be output based on the change. In FIG. 9A, the information processing device 10 receives the detection signal Sig1 indicating the direction of the display unit 50 detected by the sensor unit 54. The information processing device 10 compares the received detection signal Sig1 with the initial set value held in the storage unit 12 and changes the drawing area based on the difference between the received detection signal Sig1 and the initial set value. As illustrated in FIG. 9A, the information processing device 10 determines that the motion is a counterclockwise rotation based on the difference between the received detection signal Sig1 and the initial set value. The information processing device 10 generates the image signal Sig2 including the object M2 based on the line of sight obtained by rotating the initial line of sight counterclockwise and outputs the generated signal to the display unit 50. The display unit 50 displays images corresponding to the image signal Sig2 on the display parts 52A and 52B. As a result, the user U can visually recognize the three-dimensional image D2 illustrated in FIG. 9B through the VR goggles. Similarly, in FIG. 10A, the information processing device 10 determines that the motion is a clockwise rotation based on the detection signal Sig1 received from the sensor unit 54 and the initial set value. The information processing device 10 generates the image signal Sig2 including the object M3 based on the line of sight obtained by rotating the initial line of sight clockwise and outputs the generated signal to the display unit 50. The display unit 50 displays images corresponding to the image signal Sig2 on the display parts 52A and 52B. As a result, the user U can visually recognize the three-dimensional image D3 illustrated in FIG. 10B through the VR goggles. As described with reference to FIGS. 8A to 10B, the information processing device 10 controls output of an image based on the information from the sensor unit 54.

As described above, in the first embodiment, it is possible to control output of an image based on the information from the sensor unit 54 from which a motion of the user U or the housing can be determined and output the image on the display parts 52A and 52B of the display unit 50. In other words, an image corresponding to the direction of the point of view of the user U can be output.

The display unit 50 outputs the detection signal Sig1 to the information processing device 10. The display unit 50 receives the image signal Sig2 generated based on the detection signal Sig1 by the information processor 10b of the information processing device 10 and displays an image. With this configuration, the first embodiment can provide a less expensive and lighter display unit not including the information processor 10b and a display system including the display unit.

The display unit 50 includes the power receiver 50a and drives the display parts 52A and 52B or the sensor unit 54 using the power supplied from the power source unit 10a of the information processing device 10. With this configuration, the first embodiment can provide a less expensive and lighter display unit not including any power source unit (e.g., a battery) and a display system including the display unit.

### Second Embodiment

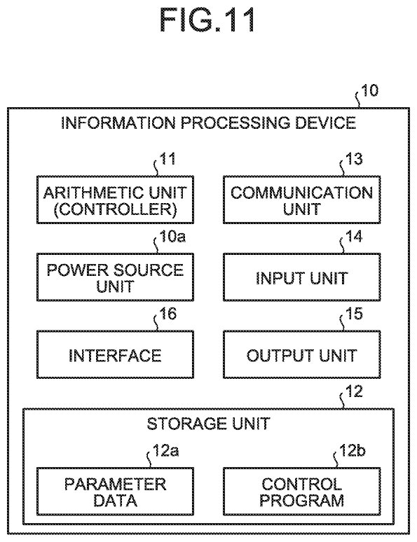

FIG. 11 is a block diagram of an exemplary main configuration of the information processing device 10 according to a second embodiment. The information processing device 10 includes the power source unit 10a, the arithmetic unit 11, the storage unit 12, a communication unit 13, the input unit 14, the output unit 15, and the interface 16. In the following description, components that are the same as those of the information processing device 10 according to the first embodiment are not described.

The communication unit 13 includes a network interface controller (NIC) for performing communications conforming to the protocol employed in a computer network N. The communication unit 13 is coupled to the computer network N, which is not illustrated, and performs processing relating to communications.

The storage unit 12 according to the second embodiment stores parameter data 12a and a control program 12b, for example, in the secondary storage device. The parameter data 12a includes parameters corresponding to the optical characteristics of the VR goggles G. The control program 12b is a computer program for generating an image corresponding to the optical characteristics of the VR goggles G based on the parameter data 12a.

The following describes the specific contents of the parameter data 12a with reference to FIGS. 12 to 14. The parameter data 12a includes a first distance OP1 of the VR goggles G, for example. The first distance OP1 is the distance between optical axes (optical axes FO1 and FO2) of two lenses L1 and L2 included in the VR goggles G.

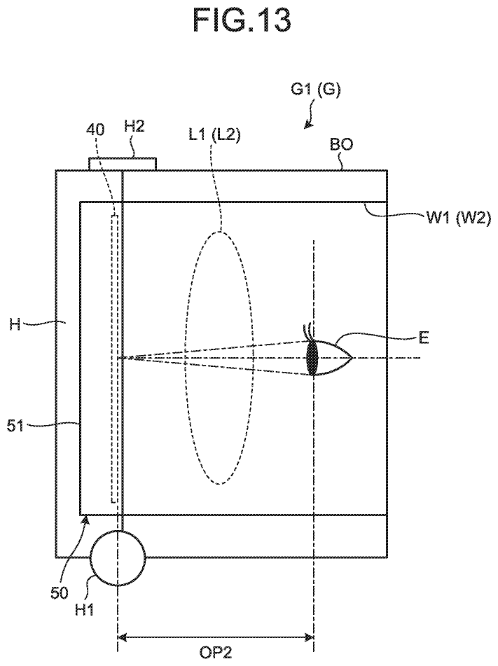

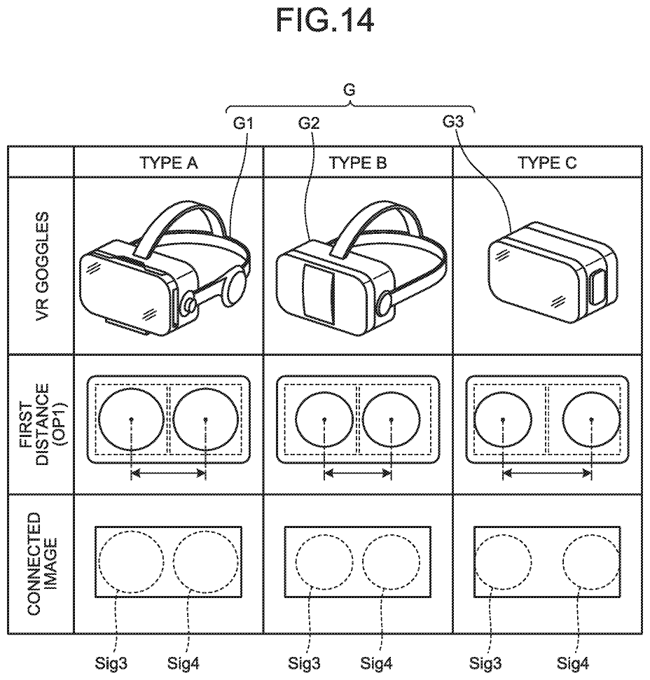

FIG. 12 is a diagram of an example of the relation between the first distance OP1 and the two display parts 52A and 52B of the VR goggles G. The housing BO has the openings W1 and W2. The user U visually recognizes images on the display parts 52A and 52B through the openings W1 and W2. The openings W1 and W2 are provided with the lenses L1 and L2, respectively (refer to FIG. 13). The first distance OP1 is determined by the positions of the lenses L1 and L2 provided in the openings W1 and W2.

The optical axis FO1 is the optical axis of the lens L1 provided in the opening W1. The optical axis FO1 is present at a predetermined position in the opening W1 in planar view along a plane orthogonal to the direction in which the user U visually recognizes an image on the display unit 50 through the VR goggles G. The optical axis FO2 is the optical axis of the lens L2 provided in the opening W2. The optical axis FO2 is present at a predetermined position in the opening W2 in the planar view. The openings W1 and W2 are included in the image display regions 41 of the display parts 52A and 52B, respectively. The positions and the sizes of the openings W1 and W2 and the lenses L1 and L2 in the housing BO are determined in advance. Consequently, the positions of the optical axes FO1 and FO2 and the first distance OP1 are determined depending on the type of the VR goggles G.

The parameter data 12a also includes a second distance OP2 to the display parts 52A and 52B of the display unit 50 supported by the VR goggles G, for example. The second distance OP2 is the distance from an eye E of the user U to either the display part 52A or the display part 52B, whichever is closer thereto. In other words, the second distance OP2 is the distance from the eye E of the user U to the image display panel 40.

FIG. 13 is a diagram of an example of the relation between the image display panel 40 of the display unit 50 supported by the VR goggles G and the second distance OP2. The eye E of the user U wearing the VR goggles G supporting the display unit 50 visually recognizes an image on the image display panel 40 of the display part 52A or 52B on the line of sight passing through the opening W1 (or the opening W2). The position of the eye E of the user U wearing the VR goggles G is substantially fixed with respect to the VR goggles G. Consequently, the second distance OP2 is determined based on the design items of the housing BO, such as the depth of the housing BO of the VR goggles Gin the line-of-sight direction. In other words, the second distance OP2 is determined depending on the type of the VR goggles G.

The VR goggles G include lenses (e.g., the lenses L1 and L2) disposed between the eye E of the user U and the image display panel 40 of the display unit 50 supported by the VR goggles G. Consequently, the second distance OP2 is determined based on the refractive index of the lenses L1 and L2.

The user U visually recognizes an image through the lenses L1 and L2. As a result, the visually recognized image has distortion (warp) corresponding to the optical characteristics of the lenses L1 and L2. In using the VR goggles G including the lenses L1 and L2, the parameter data 12a also includes parameters indicating effects caused by the distortion.

FIG. 14 is a diagram of an example of the relation between a plurality of types of VR goggles G, difference in the optical characteristics, and the positions of the images for the respective two display parts 52A and 52B in the connected image region. FIG. 14 illustrates VR goggles of three types: VR goggles G1, G2, and G3. In the example illustrated in FIG. 14, the first distance OP1 of the VR goggles G2 is shorter than the first distance OP1 of the VR goggles G1. In the example illustrated in FIG. 14, the first distance OP1 of the VR goggles G3 is longer than the first distances OP1 of the VR goggles G1 and G2. Consequently, the positions of the images for the respective two display parts 52A and 52B in the connected image based on the image signal Sig2, which is obtained by connecting the images displayed in the respective image display regions 41 of the two display parts 52A and 52B, are controlled depending on the type of the VR goggles G.

In FIG. 14, reference numerals (Sig3) and (Sig4) are allocated to the positions of the images for the respective two display parts 52A and 52B in the connected image to indicate the relation with the output signals Sig3 and Sig4. Specifically, compared with the positions of the respective two images corresponding to the output signals Sig3 and Sig4 generated based on the connected image for the display unit 50 supported by the VR goggles G1, the distance between the two images corresponding to the output signals Sig3 and Sig4 generated based on the connected image for the display unit 50 supported by the VR goggles G2 is short. The distance between the two images corresponding to the output signals Sig3 and Sig4 generated based on the connected image for the display unit 50 supported by the VR goggles G3 is longer than the distance between the two images in the connected image for the display unit 50 supported by either of the VR goggles G1 and G2.

The arithmetic unit 11, which reads the parameter data 12a and the control program 12b and performs processing, controls the distance between the two images corresponding to the output signals Sig3 and Sig4 in the connected image corresponding to the type of the VR goggles G described with reference to FIG. 14. Specifically, the parameter data 12a includes in advance parameters indicating the optical characteristics of a plurality of types of VR goggles G (e.g., VR goggles of three types: the VR goggles G1, G2, and G3). The arithmetic unit 11 reads and executes the control program 12b, thereby being able to receive selection input for specifying any one of the types of VR goggles G included in the parameter data 12a. The input unit 14 according to the present embodiment is a circuit that receives an input operation performed by the user U on the information processing device 10 and transmits information on the input operation to the arithmetic unit 11. If the type of the VR goggles G to be used is specified by the input operation performed by the user U through the input unit 14, the arithmetic unit 11 reads the parameters of the optical characteristics corresponding to the specified type of the VR goggles G from the parameter data 12a to control the distance between the images for the respective two display parts 52A and 52B in the connected image for the display unit 50. As described above, the arithmetic unit 11 reads the parameter data 12a and the control program 12b and performs processing, thereby functioning as a controller that controls output of an image based on any one item of the parameter data 12a for a plurality of types of VR goggles G. In the same manner as the first embodiment, the connected image data corresponding to the parameter data 12a created by the arithmetic unit 11 is transmitted to the display unit 50 via the output unit 15 and the interface 16 as the image signal Sig2. The display unit 50 includes a signal processor 20 similar to the signal processor 20 of the first embodiment and generates the output signals Sig3 and Sig4 from the image signal Sig2 to display them on the display parts 52A and 52B. The user U visually recognizes a three-dimensional image through the lenses of the VR goggles G based on the images displayed on the display parts 52A and 52B. Detailed explanation of the configuration is omitted herein because it is similar to the first embodiment.

The distance between the image regions corresponding to the respective output signals Sig3 and Sig4 in the connected image corresponds to the distance obtained by subtracting the distance between the display parts 52A and 52B from the first distance OP1. The two display parts 52A and 52B preferably have the image display regions 41 that can sufficiently cover the openings W1 and W2 of VR goggles G of all the types. While FIG. 14 illustrates the difference in the first distance OP1 as an example of the difference in the parameters of the optical characteristics of the respective types of VR goggles G, the parameters of other optical characteristics, such as the second distance OP2, may differ depending on the types of VR goggles G. The arithmetic unit 11 controls the aspect of the images for the respective two display parts 52A and 52B included in the connected image based not only on the first distance OP1 but also on the parameters of other optical characteristics, such as the second distance OP2.

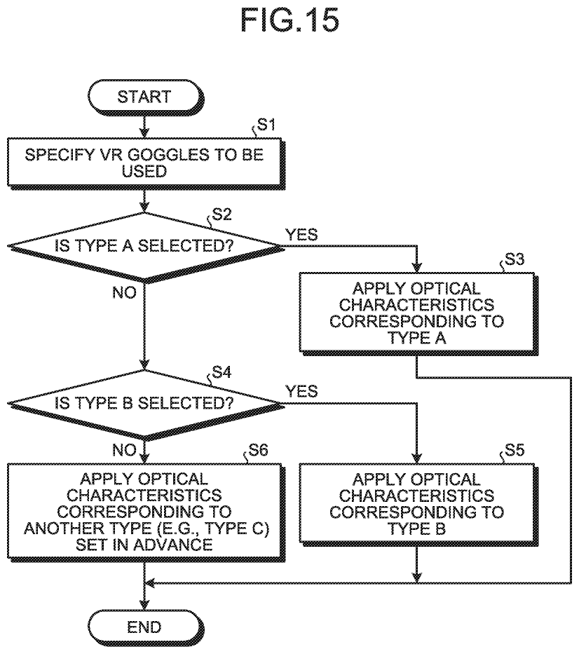

FIG. 15 is a flowchart of an example of a procedure corresponding to the optical characteristics. If the user U performs setting for specifying the VR goggles G to be used (Step S1), the arithmetic unit 11 determines whether the VR goggles G1 of a type A are selected (Step S2). If the arithmetic unit 11 determines that the VR goggles G1 of the type A are selected (Yes at Step S2), the arithmetic unit 11 reads the parameters of the optical characteristics corresponding to the VR goggles G1 of the type A from the parameter data 12a and applies them to control of the images for the respective two display parts 52A and 52B in the connected image (Step S3). By contrast, if the arithmetic unit 11 determines that the VR goggles G1 of the type A are not selected in the processing at Step S2 (No at Step S2), the arithmetic unit 11 determines whether the VR goggles G2 of a type B are selected (Step S4). If the arithmetic unit 11 determines that the VR goggles G2 of the type B are selected (Yes at Step S4), the arithmetic unit 11 reads the parameters of the optical characteristics corresponding to the VR goggles G2 of the type B from the parameter data 12a and applies them to control of the images for the respective two display parts 52A and 52B in the connected image (Step S5). By contrast, if the arithmetic unit 11 determines that the VR goggles G2 of the type B are not selected in the processing at Step S4 (No at Step S4), the arithmetic unit 11 reads the parameters of the optical characteristics corresponding to another type, such as the VR goggles G3 of a type C, from the parameter data 12a and applies them to control of the images for the respective two display parts 52A and 52B in the connected image (Step S6).

As described with reference to FIG. 15, the arithmetic unit 11 controls the images based on the parameters of the optical characteristics corresponding to the type of the specified VR goggles G. While the number of types of the VR goggles G in the description with reference to FIGS. 14 and 15 is three, that is, the VR goggles G1, G2, and G3, the types of the VR goggles G are not limited thereto. The number of types of VR goggles G may be two or four or more.

As described above, according to the second embodiment, the parameters corresponding to the optical characteristics of a plurality of types of VR goggles G are independently stored for each of the types of VR goggles G, and output of the images is controlled based on any one of the parameters of the respective types of VR goggles G. Consequently, control based on the parameters corresponding to specification of the type of the VR goggles G is performed, thereby displaying the images corresponding to the optical characteristics of the VR goggles G.

The parameters include the first optical distance OP1 of the VR goggles G, thereby outputting the images corresponding to the distance between the optical axes (optical axes FO1 and FO2) of the two lenses L1 and L2 included in the VR goggles G.

The image output by the information processing device 10 is an image corresponding to the image region having a size equal to the sum of the sizes of the two image display regions 41 of the two display parts 52A and 52B. The display unit 50 divides the image into divided images corresponding to the image display regions 41 of the respective two display parts 52A and 52B and outputs them to the two display parts 52A and 52B. Consequently, the display unit 50 of the second embodiment can display the images using the two display parts 52A and 52B based on one frame image output from the information processing device 10.

While the display parts 52A and 52B in the description above are liquid crystal display devices, the specific aspect of the display parts 52A and 52B is not limited thereto. The display parts 52A and 52B may be organic electroluminescence (EL) display devices including EL elements serving as display elements, μ-LED display devices, mini-LED display devices, or other display panels including electromagnetic induction elements, for example.

Part or all of data transmission or supply of power using the cable 55 in the description above may be performed wirelessly. While the first embodiment exemplifies a case where the display unit 50 includes neither the power source unit nor the information processor 10b, the display unit 50 may include one of the power source unit and the information processor 10b or part of their functions. Another power source for causing the display unit 50 to operate, for example, may be provided like a case where the display unit 50 includes a battery.

While the second embodiment exemplifies a case where the user U performs an input operation through the input unit 14 of the information processing device 10, the method for specifying the type of the VR goggles G is not limited thereto. The VR goggles may include a storage unit that stores therein information on the type of the goggles and a transmitter that transmits the information on the type of the goggles to the display unit 50 housed therein. When the display unit 50 is housed in the VR goggles, the sensor unit of the display unit 50 transmits the information on the type of the goggles transmitted from the transmitter of the VR goggles, to the information processing device 10 via the interface 53 and the cable 55. The information processing device 10 may receive the information on the type of the goggles via the interface 16 and the input unit 14 and generate a connected image based on the corresponding parameters.

While the three-dimensional image is displayed by the user U viewing the images displayed on the display parts 52A and 52B through the lenses of the VR goggles in the description above, the three-dimensional image is not limited to a VR image and includes an AR image and an MR image.

Out of other advantageous effects provided by the aspects described in the embodiments, advantageous effects clearly defined by the description in the present specification or appropriately conceivable by those skilled in the art are naturally provided by the present disclosure.

What is claimed is:

1. A display system comprising:
a display device attached to VR goggles; and
an information processing device configured to output an image to the display device, wherein
the display device comprises
a sensor configured to supply a detection signal indicating a motion of the display device, and
at least one display part with an image display panel, the information processing device comprises
an information processor configured to receive information detected by the sensor and generate an image signal based on the information, and
the display part displays an image based on the image signal generated by the information processor.

2. The display system according to claim 1, wherein
the display device comprises two display parts,
the information processor of the information processing device generates the image signal corresponding to a connected image obtained by connecting images corresponding to the two display parts based on the information detected by the sensor, and
the display device comprises a signal processor configured to divide the image signal corresponding to the connected image received from the information processing device, and the two display parts display images resulting from the division by the signal processor.

3. The display system according to claim 1, wherein
the information processing device comprises a power source unit configured to supply power to the display device, and
the display device comprises a power receiver configured to receive the power from the power source unit.

4. The display system according to claim 3, wherein the display device drives the sensor based on the power received by the power receiver from the power source unit.

5. The display system according to claim 3, wherein the display device drives the display part based on the power received by the power receiver from the power source unit.

6. The display system according to claim 1, wherein the display device comprises neither a battery nor an information processor configured to generate an image based on a detection signal from the sensor.

7. The display system according to claim 1, wherein
the display device is held in front of the eyes of a user by the VR goggles, and
the sensor of the display device outputs a detection signal indicating a motion of the eyes of the user.

8. The display system according to claim 1, wherein
the display device comprises two display parts, and
the information processing device comprises:
a storage unit configured to store therein parameters corresponding to optical characteristics of a plurality of types of VR goggles independently for each of the plurality of types of VR goggles; and
a controller configured to control output of the image based on any one of the parameters of the plurality of types of VR goggles.

9. The display system according to claim 8, wherein the parameters include a distance between optical axes of two lenses included in the VR goggles.

10. A display device attached to VR goggles, the display device comprising:
a sensor configured to acquire a detection signal indicating a motion of the display device;
an interface configured to supply the detection signal acquired by the sensor to an information processing device and acquire an image signal generated by the information processing device based on the detection signal; and
at least one display part configured to display an image based on the image signal supplied from the information processing device.

11. The display device according to claim 10 comprising:
two display parts; and
a signal processor configured to receive the image signal corresponding to a connected image obtained by connecting images corresponding to the two display parts generated based on information detected by the sensor and divide the image signal corresponding to the connected image, wherein
the two display parts display images resulting from the division by the signal processor.

12. The display device according to claim 10, wherein the display device comprises neither a battery nor an information processor configured to generate the image based on the detection signal from the sensor.

13. The display device according to claim 10 comprising: two display parts configured to display an image based on the image signal controlled by the information processing device so as to correspond to optical characteristics of the VR goggles.

14. The display device according to claim 13, wherein the optical characteristics include a distance between optical axes of two lenses included in the VR goggles.
